(19) United States
(12) Patent Application Publication
(10) Pub. No.: US 2013/0278868 A1
(43) Pub. Date: Oct. 24, 2013

(54) Optically Isolated Cavity For Light Sensor Feedback in LCD

(71) Applicant: Manufacturing Resources International, Inc., Alpharetta, GA (US)

(72) Inventors: William Dunn, Alpharetta, GA (US); Rick De Laet, Alpharetta, GA (US); Martin Jarl, Alpharetta, GA (US)

(21) Appl. No.: 13/707,762

(22) Filed: Dec. 7, 2012

Related U.S. Application Data
(60) Provisional application No. 61/567,879, filed on Dec. 7, 2011.

(51) Int. Cl. G02F 1/133

(52) U.S. Cl. CPC G02F 1/13318
USPC 349/69; 362/97.1

(57) ABSTRACT

Disclosed herein is a light emitting diode (LED) backlight assembly having a mounting substrate with a plurality of LEDs where an optically-isolated cavity is positioned near an edge of the mounting substrate. An information block LED is positioned within the optically-isolated cavity so that light emitted from the main LEDs do not interfere with the light emitted by the information block LED. A liquid crystal stack may be positioned above the LEDs where a portion of the liquid crystal stack is designated as an information block which can be measured by a light sensor. The optically-isolated cavity can be formed by light absorbing and/or reflecting material and may contain one or more walls of the backlight cavity.

### CROSS-REFERENCE TO RELATED APPLICATIONS

This application claims priority to U.S. Application No. 61/567,879 filed on Dec. 7, 2011 and is herein incorporated by reference in its entirety.

### TECHNICAL FIELD

Exemplary embodiments generally relate to an optically isolated cavity within an LED backlight for improved measurements from a light sensor placed in front of the LCD.

### BACKGROUND OF THE ART

Electronic displays have previously been used predominantly in indoor entertainment applications such as home theatres and bars/restaurants. However, as the performance characteristics and popularity have grown, electronic displays are now being used in many new environments for both entertainment as well as informational and advertising purposes. Displays are now used in airports, shopping malls, sides of buildings, arenas/stadiums, menu boards, and as advertising signs and/or billboards. Exemplary displays are also used for both indoor and outdoor environments.

Over many hours of use, even the most reliable electronic displays are known to degrade in performance or possibly have one or more components fail prematurely. When a display is used for advertising purposes, a sudden failure or degradation in performance can result in the loss of critical advertising exposure and possible revenue to the advertising firm. Further, when a display is used for information, a failure of the display may result in the loss of critical information such as flight schedules or emergency alerts. Also, in some applications a display is required to maintain a certain level of performance (ex. gamma, contrast, luminance, color saturation, etc.). A user may want to monitor the various parameters of the display to determine when the display may begin to degrade in performance.

When displays are used for advertising purposes, it may be desirable to include the capability to monitor the performance of the displays. More specifically, it may be desirable to confirm that the advertisement was successfully shown on the display. Collecting and storing the confirmation data may be useful to advertisers which desire the specific times, frequency, and location data for their advertisements. It may also be desirable to ensure that the video/images being sent to a display cannot be tampered with or to ensure that undesirable content cannot be shown on a display.

It is now possible to designate a portion of the electronic display for measuring the performance of the display, interpreting embedded codes, and a host of other features. This portion of the electronic display may be referred to as an ‘information block.’ A light sensor may be positioned in front of the information block to provide an optical/electrical feedback for the data that is being displayed within the information block. Further details on this design can be found in application Ser. No. 12/706,594 filed on Feb. 16, 2010; the contents of which are herein incorporated by reference in its entirety.

It is now possible to create a unique identifier for each unique piece of video/image content. The unique identifier may be encoded and sent to the information block for displaying simultaneously with the video/image content. The information block may be measured by a light sensor where this data is then decoded and stored. The decoded data can later be compared with the original unique identifier in order to confirm that the image was actually shown on the display and when. Thus, if a unique identifier is not present or is in an improper format then the video/image being displayed is not intended and may immediately be removed from the display. Thus, exemplary embodiments can not only provide confirmation that a video/image was shown but can also provide a level of security so that unauthorized video/images cannot be shown on the display. The details for operating this type of design can be found in application Ser. No. 12/763,797 filed on Apr. 20, 2010; the contents of which are herein incorporated by reference in its entirety.

It has been found, that when using the information block and light sensor technique with an LED-backlit LCD, there can be issues when interpreting the light sensor data, as this can be effected by the particular performance of the LED backlight at that time. It is known for LED backlights to change in overall intensity (sometimes dependent upon the amount of ambient light present) or to change in relative intensity due to dynamic block dimming. These can interfere with the area of the LCD designated as the information block and can cause the light sensor to provide data which may be inaccurate.

### SUMMARY OF THE EXEMPLARY EMBODIMENTS

The exemplary embodiments utilize a specifically placed information block LED and provide an optically isolated cavity around the information block LED to improve the accuracy of the light sensor and reduce or eliminate any susceptibility to changes in the overall LED backlight. Some embodiments surround the information block LED with light absorbing block.

The foregoing and other features and advantages will be apparent from the following more detailed description of the particular embodiments of the invention, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 shows an electrical schematic for an LCD display which contains an embodiment of the optically isolated cavity.

FIG. 2A shows a front elevation view of one embodiment for placement of the information block on the image-producing portion of the LCD.

FIG. 2B shows a front elevation view of another embodiment for placement of the information block on the image-producing portion of the LCD.

FIG. 3 provides a front elevation view similar to that shown in FIGS. 2A-2B after removing the LCD and optional front display plate, leaving only the LED backlight.

FIG. 4 provides a simplified and detailed front elevation view of Detail A shown in FIG. 3.

FIG. 5A provides a first embodiment for surrounding the information block LED with an optically isolated cavity.

FIG. 5B provides another embodiment for surrounding the information block LED with an optically isolated cavity.

FIG. 6A provides a sectional view along the section line 6A-6A shown in FIG. 5A where an optional light diffusing element, LCD stack, light sensor, and optional front display plate have been replaced to illustrate the relationship between these layers.

FIG. 6B provides a sectional view along the section line 6B-6B shown in FIG. 5B where the LCD and light sensor have been replaced to illustrate the relationship between these layers.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

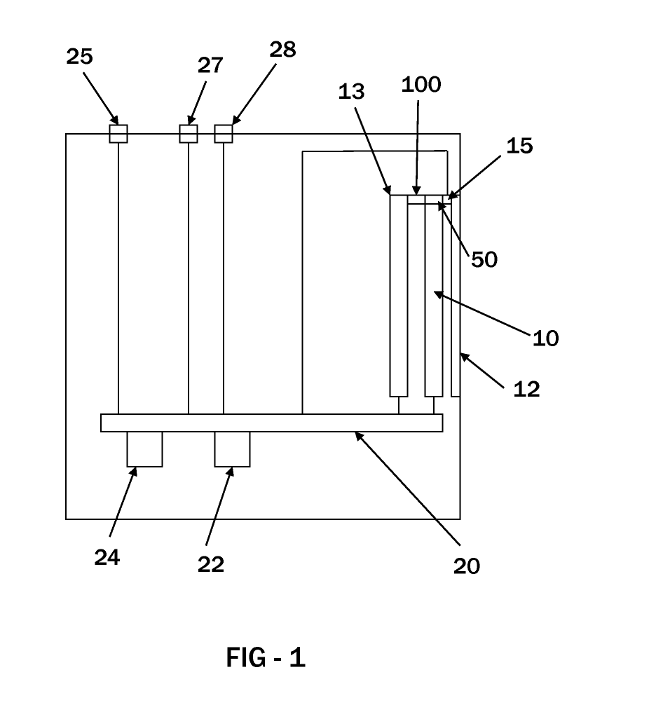

FIG. 1 shows an electrical schematic for an LCD display 10 which contains an embodiment of the display feedback system and optically isolated cavity 100. A light sensor 15 may be placed in front of the information block 50, which may be a designated portion of the LCD 10. In this embodiment, the light sensor 15 is placed between the front surface of the LCD 10 and a front display plate 12 which may protect the display or provide additional optical properties (anti-reflection, polarization, optical matching, light absorption, etc.). This plate 12 is not necessary but may be preferable to protect the various components if the display will be subject to vandalism, environmental damage, or other impact from foreign objects. An LED backlight assembly 13 is preferably placed behind the LCD 10.

The LCD 10, light sensor 15, and backlight assembly 13 may be connected to a backplane 20 which can provide communication between the various components of the display. One or more power modules 22 and a display controller assembly 24 may also be in electrical communication with the backplane 20. The display controller assembly 24 may include several different components including, but not limited to a video receiving unit, decompressor, timing and control board (TCON), and display interface board (DIB). The display controller assembly 24 can also contain a local storage device (ex. hard drive, flash drive, re-writable memory, etc) so that information about the display (including information gathered from the light sensor 15) may be stored locally for possible later retrieval by the user.

The display may contain several inputs and output interfaces. A video input 25 may accept the video data from a video source and may connect to the backplane 20 or may connect directly to the display controller assembly 24. A network interface 27 may be used to provide communication between the display and the user. Through the network interface 27, the user can monitor the display's performance and possibly change various display settings. A power input 28 can provide power to the display components. Of course, some embodiments may use a different combination of input and output interfaces. For example, some embodiments may use a single interface for both receiving video/audio data as well as communicating display data back to the user. In an exemplary embodiment, network interface 27 would be a two-way wireless connection or wireless network card. The number and style of input and output connections can vary depending on the particular application and would not be outside the scope of the exemplary embodiments.

The use of a backplane 20 is not required as each component could be in electrical communication through wiring which runs to each component. However, it has been found that manufacturing times may be decreased by allowing each component to simply connect with the backplane 20 and through the backplane 20 the components may communicate with each other. Thus, the backplane 20 could be one or more printed circuit boards with connections for each electrical component and conduction lines which permit each component to communicate with one another.

It should be noted that the information block 50 does not have a required shape (i.e. it does not actually have to be a block, square, or rectangle). The information block 50 is simply a grouping of image elements (e.g. pixels) which are designated for measurement by the light sensor 15. In some embodiments the information block 50 may be approximately 8×8 pixels. In some embodiments the information block 50 may be approximately ¼ inch×¼ inch in size. The information block 50 could be placed anywhere on the display, but since the light sensor 15 should preferably be placed in front of a portion of the viewable (image-producing) area of the LCD 10, the information block 50 should preferably be placed in a corner or near the edge of the LCD 10 so that the image is only disrupted a minimal amount. The data for the information block 50 may be sent to the LCD 10 by one or more components of the display controller assembly 24.

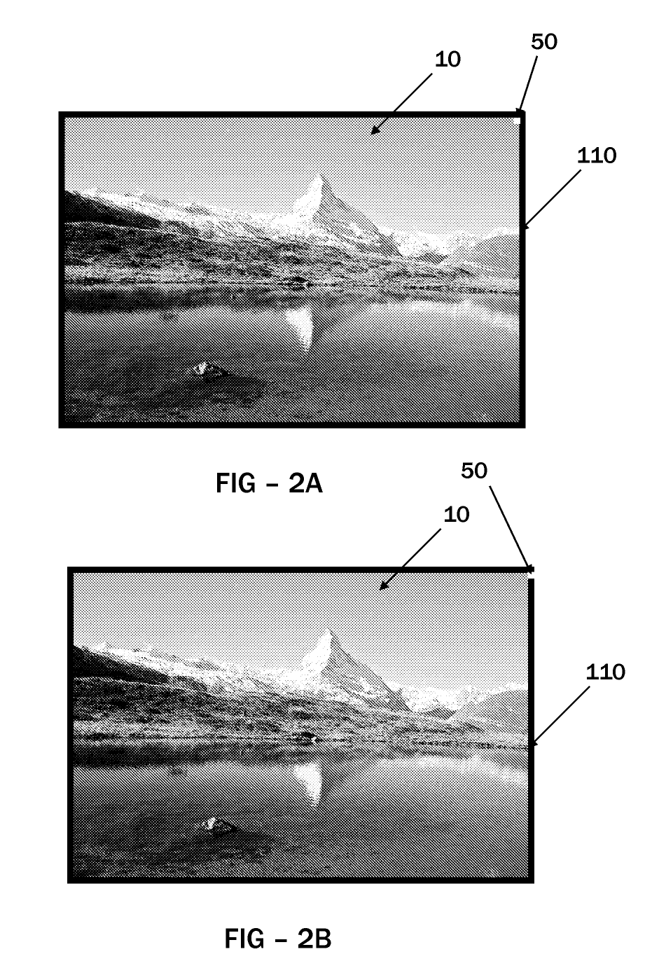

FIG. 2A shows one embodiment for placement of the information block 50 on the image-producing portion of the LCD 10. Preferably, the light sensor 15 (not shown in this Figure for clarity) is placed directly in front of the information block 50. The sensor 15 may or may not be placed behind a transparent front display plate. To minimize the impact on the viewable image on the display, the information block 50 and sensor 15 should be relatively small and should preferably be placed relatively close to a corner or edge of the LCD 10. As known in the art, a black mask 110 is sometimes used to surround the image-producing portion of the LCD to provide a more aesthetically pleasing look to the display by uniformly covering any electronics which are connected to the LCD. In this embodiment, the information block 50 is not placed behind this mask 110. Conversely, the embodiment shown in FIG. 2B places the information block 50 behind the mask 110 so that it would not be visible to the observer. In these embodiments it may be beneficial to increase the coverage of the mask 110 so that it would provide adequate room for the information block 50.

Obviously, one of ordinary skill in the art can place the light sensor in a number of different places to provide the same effect. Multiple sensors could be also be used to provide additional measurements, or perhaps measure different information blocks simultaneously (possibly containing different information).

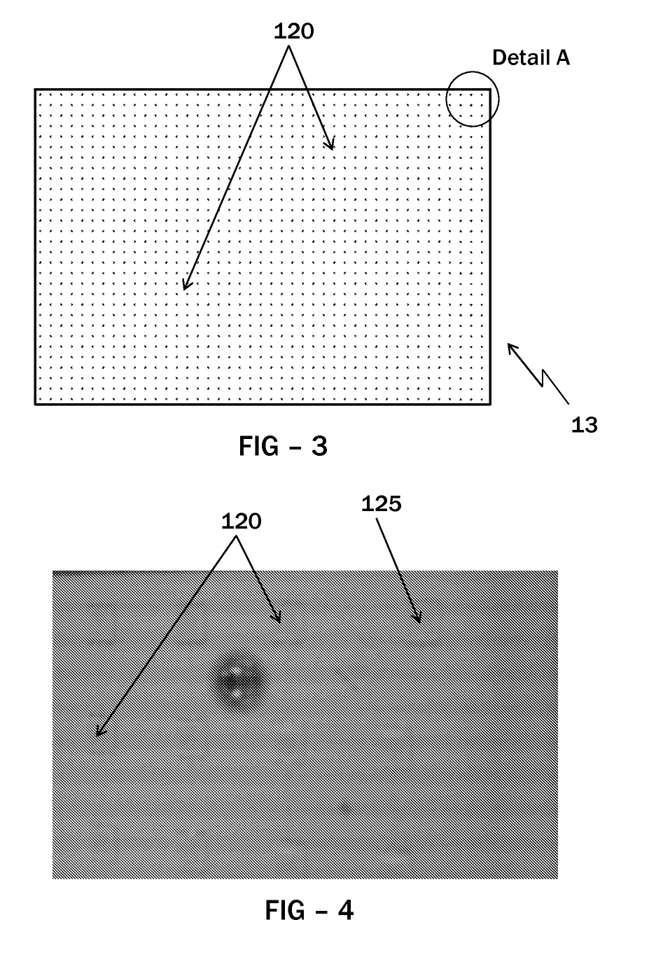

FIG. 3 provides a front view similar to that shown in FIGS. 2A-2B after removing the LCD and optional front display plate, leaving only the LED backlight 13. A plurality of LEDs 120 are mounted to a substrate (typically a printed circuit board (PCB) and in an exemplary embodiment a metal core PCB).

FIG. 4 provides a simplified and detailed front view of Detail A shown in FIG. 3. In addition to the LEDs 120 spread across the backlight 13, there is an additional LED 125 which is positioned for illuminating the information block 50 of the LCD 10. The LED 125 is surrounded by the optical cavity 100 so that it will be optically isolated from the light generated by the remaining LEDs 120.

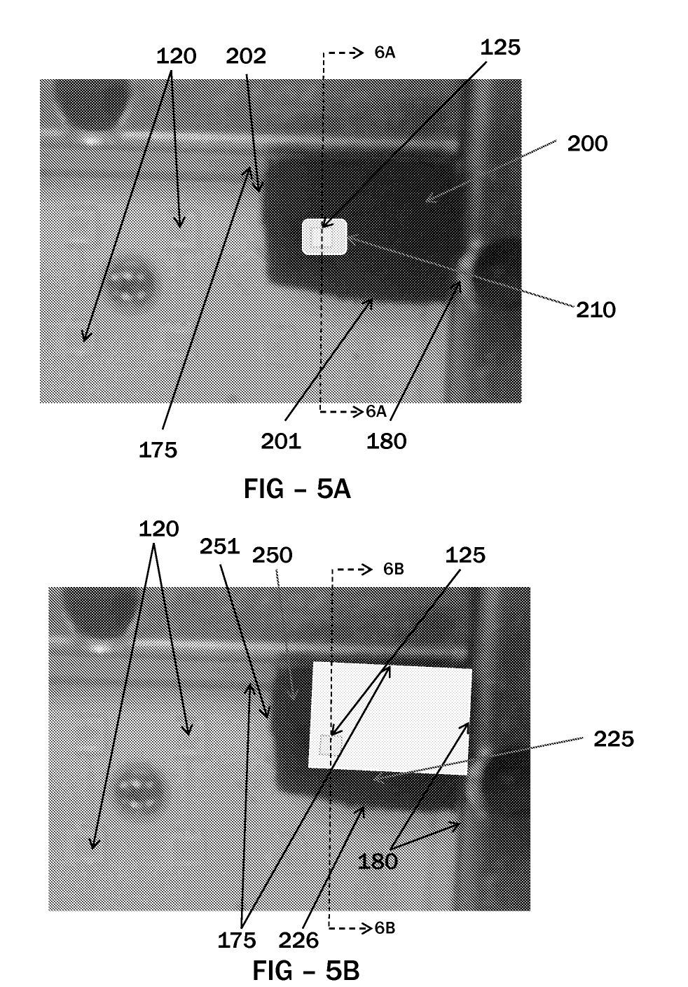

FIG. 5A provides a first embodiment for surrounding the LED 125 with an optical cavity 100. Here, a light-absorbing block 200 is placed atop the LED 125 with a pass-through aperture 210 positioned right above the LED 125. In this particular embodiment, the light-absorbing block 200 is posited adjacent to the side surfaces 175 and 180 of the backlight cavity. While this embodiment places the light-absorbing block 200 in the corner of the backlight cavity, it could be placed anywhere along the edge of the backlight cavity as well. One or more surfaces 202 and 201 of the light-absorbing block 200 may face the remainder of the backlight LEDs 120. An exemplary embodiment may place a reflective and diffuse substrate on these surfaces 202 and 201 to prevent this area of the backlight from being ‘dark’ or having non-uniform lighting patterns due to the light-absorbing properties of the block 200. It may further be desirable to place a reflective and diffuse substrate on the side surfaces 175 and 180 of the backlight cavity.

FIG. 5B provides another embodiment for surrounding the LED 125 with an optical cavity 100. Here, a pair of walls 250 and 225 are used to isolate the LED 125 from the remaining LEDs 120. The walls 250 and 225 may be light-absorbing or may be reflective and diffuse. The wall 250 preferably extends from the backlight cavity sidewall 175 to meet the wall 225, which extends from the backlight cavity sidewall 180. The LED 125 may be laterally bounded between the two walls 250 and 225 and the two backlight cavity sidewalls 175 and 180. Similar to above, it may be preferable to cover the surfaces 226 and 251 of the walls 225 and 250 with a reflective and diffuse substrate. Again, although shown in the corner of the backlight cavity, the LED 125 could be positioned along the edge where the optical cavity 100 is defined by one backlight cavity sidewall and three light-absorbing or reflective walls.

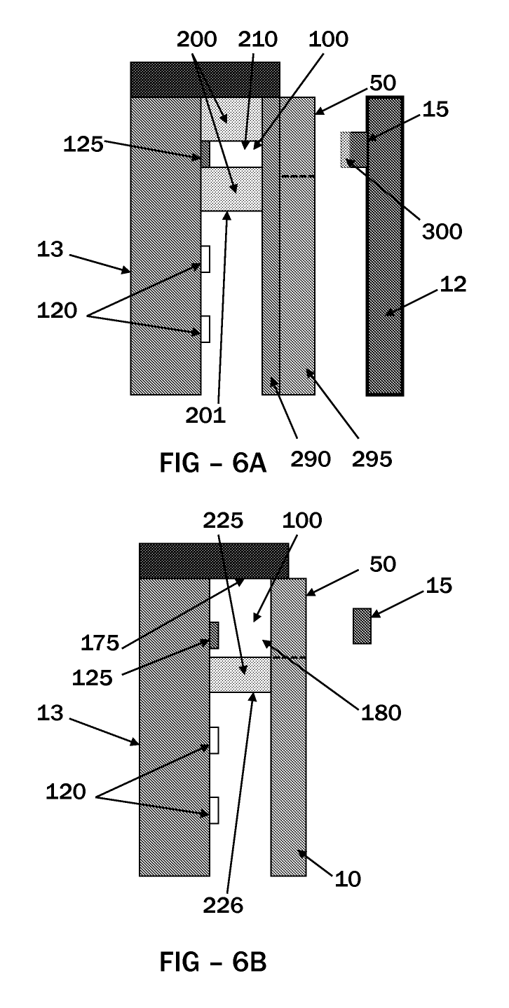

FIG. 6A provides a sectional view along the section line 6A-6A shown in FIG. 5A where the light diffusing element 290, LCD stack 295, light sensor 15, and front display plate 12 have been replaced to illustrate the relationship between these layers. In this embodiment, the LED 125 is surrounded laterally by the light-absorbing block 200, with the backlight (substrate) 13 below and a light diffusing element 290 above. The light diffusing element 290 is an optional element and may be used to increase the uniformity of the light coming from LEDs 125 and 120. A LCD stack 295 is typically placed in front of the light diffusing element 290 and may contain a number of layers which are known in the art (rear/front polarizers, color plate, TFT or other electronic controlling layer, and the layer of liquid crystal material). The information block 50 is positioned roughly in front of the LED 125 and the optically-isolated cavity 100.

This embodiment also uses the optional front display plate 12 in front of the light sensor 15 and the LCD stack 295. It has been found, that in some applications where the display is used in an outdoor and/or bright ambient environment, the ambient light may reflect off the LCD stack 295 and enter the light sensor 15. In these applications, the light sensor 15 may become oversaturated with light so that it may not be able to accurately read the optical performance of the information block 50. In these situations it has been found that placing an optional filter 300 between the light sensor 15 and the LCD may alleviate some of these problems. An exemplary embodiment may use a ‘hot mirror’ type IR filter. Some embodiments may use any type of filter that removes or reduces electromagnetic radiation having wavelengths longer than 600-650 nanometers. The filter 300 may be bonded to the light sensor 15 using pressure sensitive adhesive.

FIG. 6B provides a sectional view along the section line 6B-6B shown in FIG. 5B where the LCD 10 and light sensor 15 have been replaced to illustrate the relationship between these layers.

It should be noted that the embodiments herein have been shown and described with respect to white LEDs. It is known to create LCD backlights with a variety of LED colors and combinations. For example and illustration, some of the combinations typically used are: white LEDs; red, green, and blue LEDs; red, green, blue, and yellow LEDs; as well as multiples of these and other colors (i.e. two blue LEDs or a cyan LED). The invention herein is not limited to any particular combination of LEDs. Where singular white LEDs are shown and described herein, it may easily be substituted with any of the LED combinations available for creating LCD backlights.

As discussed above in the related applications, the light sensor 15 may be used to interpret a unique identifier that can be displayed by the information block 50. Once it has been transmitted to a display, the embedded unique identifier should be displayed simultaneously with the image/video that it represents. Depending on the length of time that the image/video is being displayed, the encoded unique identifier may be shown one or more times by the information block. While displaying the unique identifier, the information block may be measured with the light sensor and the data from the light sensor is then decoded and stored. The decoded light sensor data could be stored locally (i.e. at the display) and later accessed by a user from one of the network connections. Alternatively, each time the light sensor data is stored it could be pushed to an external network server or computer database for later access by a user. Alternatively, the data could be pushed to an external network server or computer hourly, daily, or once a certain amount of data had been locally stored. Further, the light sensor data could be immediately analyzed to determine if the decoded unique identifier matches the original unique identifier. If not, an error could be stored or an error message could be sent to the user through email, text message, or other notification on a web application. Otherwise, the decoded light sensor data could be simply stored for later access and analysis by a user. The decoded light sensor data could also be stored with the corresponding data of when it was shown, the display on which it was shown, and other corresponding data. Thus, all of the stored data could be analyzed to determine if/when there was a failure, how long the failure lasted for, precisely which images/videos were shown (or failed to show) along with their frequency and precise display locations (geographical).

In some embodiments, a security feature could be enabled where the light sensor data is analyzed in real time to ensure that the current video/image data is an authorized transmission. For example, the light sensor data could be analyzed for proper formatting or even for existence at all. If no light sensor data is being decoded or if the light sensor data is not of the expected format, the current video/image display may cease as this may not be the intended and authorized transmission. This can be especially useful when trying to prevent tampering or ‘hackers’ from sending unauthorized video/images to the display.

The encoded unique identifier may be designed to correspond with the particular type of light sensor 15 being used. There are many ways to accomplish this in order to optically transmit the unique identifier through the LCD (information block 50) and to the light sensor 15.

In a first embodiment, the light sensor 15 may simply be designed to interpret between black and white shapes. Thus, black may represent 0, white may represent 1, and the encoded unique identifier can be represented in this simple binary format to the light sensor 15.

In a second embodiment, the light sensor 15 may be designed to interpret between additional colors: red, blue, green, and white where each shade could take on a two bit value and represent 0, 1, 2, and 3 respectively. Any type of color light sensor could be used here while an exemplary color light sensor might be the TCS3404CS or TCS3414CS which are commercially available from Texas Advanced Optoelectronic Solutions® (TAOS) of Plano, Tex. www.taosinc.com. The TAOS specification document TAOS068 entitled TCS3404CS, TCS3414CS Digital Color Light Sensors' is herein incorporated by reference in its entirety.

In a third embodiment, the light sensor 15 may be a CCD camera and could thus interpret a matrix of time varying image elements in the information block 50. As is known in the art, the size of the light measurement elements of CCD cameras are typically much smaller than the size of pixel elements of electronic displays. Thus, a CCD camera (or similar type of light measurement device) could interpret several ‘data points’ (i.e. groupings of image pixels) simultaneously and could therefore transfer more data in the same amount of time.

Some embodiments may not report errors out to the user immediately, but instead may simply store the data internally for later retrieval by the user. In an exemplary embodiment, the performance data may be accessed by the user through a web browser which communicates with one of the network interfaces of the display. Once the data is retrieved and analyzed it may be determined that the display has malfunctioned and may continue to malfunction and possibly needs servicing or replaced.

Exemplary embodiments provide constant feedback on the performance of the display and can quickly notify the user that the display is not functioning properly. Notifications may be sent to the user's computer, cell phone, or smart device through any of the output data interfaces. A variety of internet notifications could be sent to the user through the network interface 27. Notifications could include email, instant messaging, text messaging, or a web page which can be accessed by the user and may contain the data for a number of different displays. The display may have been malfunctioning for some time before the user actually notices the failure. Further, in some applications there may be many displays installed and it may be very difficult to constantly monitor each displays performance. The exemplary embodiments allow constant monitoring from a remote location.

The display controller assembly 24 may generate and display the same information block regardless of the video which is being displayed. This style may be adopted when the display performance parameters are the only main concern to the user. Alternatively, each video stream may include its own specific information block. This method would be advantageous if the user desired to measure the precise amount of time that each video is being displayed and confirming that the video was actually shown on a particular display. This would allow an advertising firm to determine exactly how long each client's advertisements were shown and on which specific displays. This can be advantageous when many different displays are being used to advertise for many different clients. This would also permit very precise and accurate billing to the clients of the advertising firm. As mentioned above, advertising prices could vary depending on location of the display, time of day shown, and the number of times the ad was shown.

The embodiments herein allow for a near instantaneous detection of failures in communication between display components, including but not limited to the TCON, DIB, LCD, all of the cabling/connections in between, as well as the video/image signal transmitting and receiving devices.

For advertising/information applications it may be important to be able to determine if video/images were actually properly transmitted to a display and then ultimately shown on the screen. There are several components that must work in harmony and a failure can result in loss of video to some or all of the displays. When using wireless transmission systems, other wireless systems or electromagnetic interference can also prevent some displays from receiving the video signals and displaying them properly. It is important that some advertising companies can actually confirm that certain portions of video were actually shown on a specific number of displays. The embodiments herein allow them to carefully track which video segments were shown, how long, and precisely on which displays. Advertisers may even charge a different rate for each display (depending on its location) or time of day.

It should be noted that while certain embodiments are described with respect to images, video, or video/image content, these terms are largely interchangeable because video is essentially a series of images. While compression techniques are often used with video where entire full frames are not sent as the content (i.e. only 1 out of every 3 or 4 frames is a full frame and the system may interpolate between the full frames) the embodiments herein can be used for still images as well as a series of images or partial images which can be used to produce video.

Elements herein that are indicated as light absorbing may be constructed with a number of different materials. Some embodiments may utilize dark colored foam blocks or walls to create the optically isolated cavities. Some embodiments may utilize black foam.

Having shown and described preferred embodiments, those skilled in the art will realize that many variations and modifications may be made to affect the described embodiments and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

We claim:

1. An LED backlight assembly comprising:
a mounting substrate;
a plurality of LEDs positioned on the mounting substrate;
an optically-isolated cavity positioned near an edge of the mounting substrate; and
an information block LED positioned within the optically-isolated cavity.

2. The LED backlight assembly of claim 1 wherein:
the optically-isolated cavity is defined by at least one light absorbing wall.

3. The LED backlight assembly of claim 1 wherein:
the optically-isolated cavity is defined by at least one light reflecting wall.

4. The LED backlight assembly of claim 1 further comprising:
a light-diffusing element placed above the LEDs.

5. The LED backlight assembly of claim 1 further comprising:
a backlight cavity having backlight cavity walls which surround the mounting substrate.

6. The LED backlight assembly of claim 5 wherein:
the optically-isolated cavity is defined by a pair of backlight cavity walls and a pair of light-absorbing walls.

7. The LED backlight assembly of claim 5 wherein:
the optically-isolated cavity is defined by a pair of backlight cavity walls and a pair of light-reflecting walls.

8. The LED backlight assembly of claim 1 wherein:
the optically-isolated cavity is defined by a block of light absorbing material having a pass through aperture which is positioned above the information block LED.

9. The LED backlight assembly of claim 5 wherein:
the optically-isolated cavity is defined by a backlight cavity wall and three light-absorbing walls.

10. The LED backlight assembly of claim 5 wherein:
the optically-isolated cavity is defined by a backlight cavity wall and three light-reflecting walls.

11. An LED backlight assembly comprising:
a backlight cavity having four side surfaces;
a printed circuit board (PCB) placed within the four side surfaces of the backlight cavity;
a plurality of LEDs positioned on the PCB;
an optically-isolated cavity positioned near a side surface of the backlight cavity; and
an information block LED positioned within the optically-isolated cavity.

12. The LED backlight assembly of claim 11 wherein:
the optically-isolated cavity contains at least one of the side surfaces of the backlight cavity.

13. The LED backlight assembly of claim 11 further comprising:
a light-diffusing element placed above the LEDs.

14. The LED backlight assembly of claim 13 wherein:
the information block LED is fully enclosed between the PCB, light-diffusing element, and the optically-isolated cavity.

15. An LED-backlit liquid crystal display (LCD) assembly comprising:
a mounting substrate;
a plurality of LEDs positioned on the mounting substrate;
an optically-isolated cavity positioned near an edge of the mounting substrate;
an information block LED positioned within the optically-isolated cavity;
a liquid crystal stack positioned in front of the LEDs; and
a light sensor positioned in front of the information block LED.

16. The LED-backlit LCD assembly of claim 15 further comprising:
a light diffusing element positioned between the liquid crystal stack and the LEDs.

17. The LED-backlit LCD assembly of claim 15 further comprising:
a network connection in electrical communication with the light sensor.

18. The LED-backlit LCD assembly of claim 15 further comprising:
an IR filter placed between the liquid crystal stack and the light sensor.

19. The LED-backlit LCD assembly of claim 15 further comprising:
a front display plate positioned in front of the light sensor.

20. The LED-backlit LCD assembly of claim 15 wherein:
the optically-isolated cavity prevents light emitted from the information block LED from interfering with light emitted by the remaining LEDs.
